(19) United States
(12) Patent Application Publication
(10) Pub. No.: US 2014/0036934 A1
(43) Pub. Date: Feb. 6, 2014

(54) METHOD AND SYSTEM FOR BURST FORMATTING OF PRECODED EGPRS2 SUPPORTING LEGACY USER MULTIPLEXING

(71) Applicants: Michael Eoin Buckley, Grayslake, IL (US); Yan Xin, Kanata (CA); Shouxing Qu, Kanata (CA); Eswar Vutukuri, Hedge End (GB)

(72) Inventors: Michael Eoin Buckley, Grayslake, IL (US); Yan Xin, Kanata (CA); Shouxing Qu, Kanata (CA); Eswar Vutukuri, Hedge End (GB)

(73) Assignee: BLACKBERRY LIMITED, Waterloo, ON (CA)

(21) Appl. No.: 14/000,845

(22) PCT Filed: Feb. 21, 2011
(86) PCT No.: PCT/US2011/025608

§ 371 Date: Oct. 22, 2013

(51) Int. Cl. H04L 27/26

(52) U.S. Cl. CPC H04L 27/2628
USPC 370/474

(57) ABSTRACT

A method and system for burst formatting of precoded EPGRS2 supporting legacy user multiplexing, the method generating, at a transmitter, a burst containing a plurality of inverse discrete Fourier transform (‘IDFT’) precoded symbols and plurality of non-IDFT precoded mid-amble symbols, wherein the IDFT precoded symbols are addressed for a first mobile device, and the non-IDFT precoded mid-amble symbols contain data addressed to a second mobile device.

### FIELD OF THE DISCLOSURE

The present disclosure relates to signaling between a network and a mobile device and in particular relates to cases where the signaling is addressed to one mobile device and is transmitted within a radio block containing a data message addressed to a second mobile device.

### BACKGROUND

A general packet radio service (GPRS) is a packet service on the global system for mobile communications (GSM). The service is designed to transfer packet data between a mobile station and network and has predefined data transfer rates. GPRS is a standard maintained by the third generation partnership project (3GPP) and is defined, for example, in the following technical standards 3GPP 7 Layer 1, General Requirements”, TS 44.004 v. 9.0.0, Dec. 18, 2000; 3GPP “General Packet Radio Service (GPRS); Mobile Station (MS)—Base Station System (BSS) interface; Radio Link Control/Medium Access Control (RLC/MAC) protocol” TS 44.060, v. 10.3.0, Dec. 22, 2010; 3GPP “General Packet Radio Service (GPRS); Overall description of the GPRS radio interface; Stage 2”, TS 43.064, v. 10.0.0, Oct. 1, 2010; 3GPP, “Physical layer on the radio path; General description”, TS 45.001, v. 9.3.0, Oct. 1, 2010; 3GPP, “Multiplexing and multiple access on the radio path TS 45.002, v. 9.4.0, Oct. 1, 2010; 3GPP “Channel Coding”, TS 45.003, v. 9.0.0, Oct. 18, 2009; and 3GPP, “Modulation” TS 45.004, v. 9.1.0, Jun. 18, 2010, the contents of all of which are incorporated herein by reference.

Enhanced general packet radio service (EGPRS) is a 3GPP rel-99 feature that enhances GSM data rates by introducing 8-PSK modulation and adaptive modulation coding schemes (MCS) with incremental redundancy. Further, evolved EGPRS (EGPRS2) is a 3GPP rel-7 feature and can double the peak data rates of EGPRS by adopting higher order modulations such as 16-QAM and 32-QAM, along with higher symbol rate (e.g. 325 ksymb/s) (HSR) and turbo codes. Further, 16 additional modulation encoding schemes, DAS-5 to DAS-12 and DBS-5 to DBS-12 are defined for EGPRS2 downlink radio blocks carrying radio link control (RLC) data blocks, as for example described in 3GPP TS 43.064. GPRS, EGPRS and EGPRS2 have a predefined burst format. In particular, the burst format has a training sequence in the middle and data, header, uplink state flag (USF), stealing flag information, and tail symbols are added to the rest of the burst. The training sequence in the middle is known in advance to both the transmitter and the receiver. In case of the transmission from network to the mobile (referred to as downlink hereafter), the legacy mobile devices operating under GPRS, EGPRS, EGPRS2A and EGPRS2B can use the known training sequence in the middle of the burst to estimate the mobile radio channel and using the knowledge of the estimated channel, equalize or undo the impact of the radio channel on the rest of the burst and decode the data, header, USF and stealing flag information.

The USF allows multiplexing mobile stations on the same packet downlink channel (PDCH), or time slot and Absolute radio-frequency channel number (ARFCN). During the establishment of an uplink temporary block flow (TBF) the mobile device is assigned a USF for each time slot in its assignment. The network indicates on a downlink radio block, in the preceding radio block period, which terminal, amongst the terminals sharing the same PDCH, is allowed to transmit in the following radio block period on the corresponding uplink timeslot of the current radio block period. In other words, the network signals to all mobile devices that are multiplexed together which mobile device is allowed to communicate in the next timeslot. Therefore, in order to allow full multiplexing of all mobile devices in the assigned uplink TBF on a given PDCH, in each downlink radio block on that PDCH, at least the USF should be encoded in such a way that it can be decoded by the mobile device to which the uplink in the next radio block period is assigned.

Similarly, Piggy backed Acknowledgement/Negative Acknowledgement (PAN) may be signaled to a device separate from the data. A PAN in a downlink radio block indicates whether the radio blocks transmitted in the uplink have been received properly by the network or not. Just like USF, the PAN could be in some embodiments addressed to a different mobile than the data in the downlink radio block.

Multiplexing using the above structure means that, in some cases, the network may transmit a USF and PAN intended for one mobile device and data for a different mobile device in the same downlink radio block. The two mobile devices may support different capabilities in some embodiments.

With the introduction of precoded EGPRS2 (PCE2), legacy devices may be unable to determine which uplink timeslot to use for transmission.

### BRIEF DESCRIPTION OF THE DRAWINGS

The present disclosure will be better understood with reference to the drawings, in which:

FIG. 1 is a diagram illustrating a burst format for a GPRS/EGPRS/EGPRS2-A burst;

FIG. 2 is a diagram illustrating a burst format for an EGPRS2-B burst;

FIG. 3 is a block diagram illustrating the encoding of an exemplary EGPRS2-A DAS-5 modulation and coding scheme;

FIG. 4 is a block diagram illustrating an exemplary burst format for a PCE2-A burst;

FIG. 5 is a block diagram illustrating an exemplary burst format for a PCE2-B burst;

FIG. 6 is a block diagram illustrating the various components used in encoding a PCE2 burst;

FIG. 7 is a block diagram illustrating the interleaving of channel coded and modulated data, USF, SB and Header symbols and modulated TSC symbols;

FIG. 8 is a block diagram illustrating the encoding DAS-5 using a PCE2 burst format;

FIG. 9 is a block diagram illustrating a burst format for a PCE2-A burst having a time domain TSC;

FIG. 10 is a block diagram illustrating a burst format for a PCE2-B burst having a time domain TSC;

FIG. 11 is a block diagram illustrating a burst format for a PCE2 burst in which the USF, some data symbols, stealing flag bits, header and PAN information may be included in such a way that at least the USF and PAN can be fully decoded by a non PCE2 mobile;

FIG. 12 is a block diagram of a burst format of a PCE2-A burst having a TSC and USF symbols that can be decoded by a non PCE2 mobile;

FIG. 13 is a block diagram of a burst format of a PCE2-B burst having a TSC and USF symbols that can be decoded by a non PCE2 mobile;

FIG. 14 is a block diagram of a burst format of a PCE2-A burst having a TSC, USF symbols, and both the tail symbol parts of the bursts that can all be used or decoded by a non PCE2 mobile;

FIG. 15 is a block diagram of a transmitter configured to encode the burst according to the format of FIG. 12;

FIG. 16 shows a block diagram of the burst of FIG. 12 in which USF data is duplicated in the IDFT precoded portion of a PCE2-A burst;

FIG. 17 shows a block diagram of the burst of FIG. 13 in which USF data is duplicated in the IDFT precoded portion of a PCE2-B burst;

FIG. 18 is a process diagram showing a method for selecting a burst format at TBF establishment;

FIG. 19 is a process diagram showing a method for selecting a burst format at each radio block period;

FIG. 20 is a process diagram showing a first embodiment for decoding a received burst;

FIG. 21 is a process diagram showing an alternative embodiment for decoding a received burst;

FIG. 22 is a block diagram illustrating an exemplary network architecture; and

FIG. 23 is a block diagram illustrating an exemplary mobile device.

### DETAILED DESCRIPTION OF THE DRAWINGS

The present disclosure provides a method comprising: generating, at a transmitter, a burst containing a plurality of inverse discrete Fourier transform (‘IDFT’) precoded symbols and plurality of non-IDFT precoded mid-amble symbols, wherein the IDFT precoded symbols contain data for a first mobile device, and the non-IDFT precoded mid-amble symbols contain data for a second mobile device.

The present disclosure further provides transmitter comprising: a processor; and a communications subsystem, wherein the processor and communications subsystem cooperate to: generate a burst containing a plurality of inverse discrete Fourier transform (‘IDFT’) precoded symbols and plurality of non-IDFT precoded mid-amble symbols, wherein the IDFT precoded symbols contain data for a first mobile device, and the non-IDFT precoded mid-amble symbols contain data for a second mobile device.

The present disclosure still further provide a method at a receiver for decoding a burst comprising: utilizing a first burst format and a second burst format to decode the burst; and checking whether a cyclic redundancy for a header of the burst matches for one of the first burst format decoding and second burst format decoding, and if yes, using the matching one of the first format decoded and second format decoded burst.

The present disclosure still further provides a method at a receiver for decoding a burst comprising: decoding the burst with both a first burst format and a second burst format; and using the decoded burst having the less noisy uplink state flag.

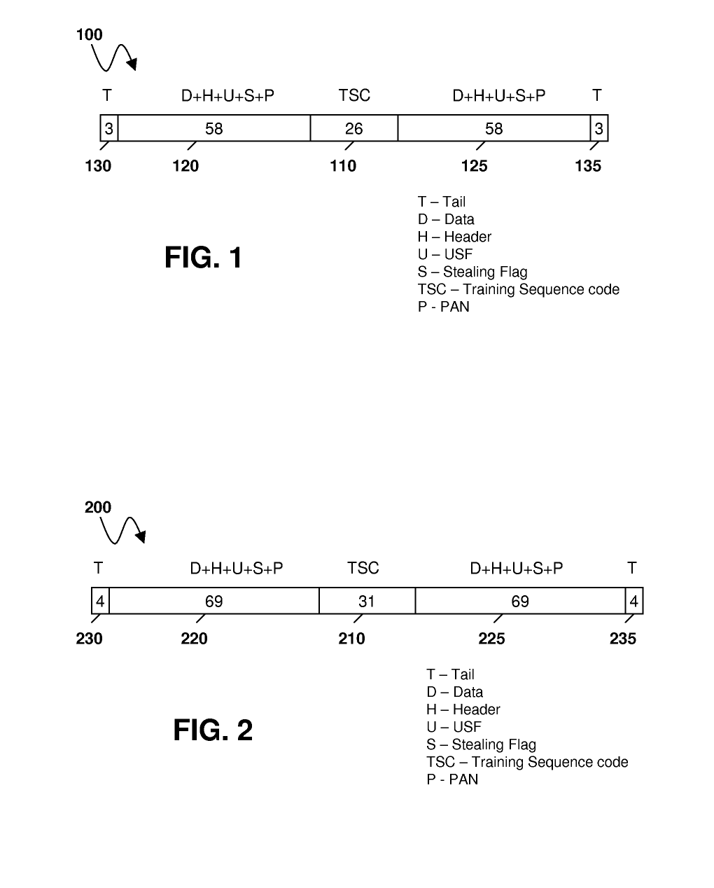

Reference is now made to FIG. 1. FIG. 1 shows a burst format for GPRS/EGPRS/EGPRS2-A, showing the format and number of symbols used for such burst format.

In FIG. 1, the burst 100 includes a training sequence code (TSC) 110, which is comprised of 26 symbols. TSC is used to train a receiver regarding channel conditions and the TSC sequence is known to both the transmitter and receiver. A total of 4 such bursts constitute one radio block. As used herein, a transmitter is any device or apparatus (or combination of devices) used for transmission. Similarly, a receiver is any device or combination of devices used for reception.

On either side of TSC 110, data+header+USF+stealing flag+PAN sections 120 and 125 are added. Sections 120 and 125 are 58 symbols each, and include a data portion that contains the coded radio link control (RLC) or medium access control (MAC) data block, which is referred to as “data” in the figures.

The USF in sections 120 and 125 controls the multiplexing of the resources in the uplink. Specifically, the USF allows the network to schedule a particular mobile device among the mobiles using the same PDCH to use the uplink in the next radio block period. During the establishment of the uplink temporary block flow, every mobile is assigned a USF for each time slot in its assignment.

The header in sections 120 and 125 contains information needed for decoding the data block and also some higher layer information. For instance, the header can contain information for controlling the hybrid automatic repeat request (HARQ) retransmissions and information on which modulation and coding scheme is used for coding of the data, among others.

The stealing flag information in sections 120 and 125 represents stealing flag bits that are used to indicate the header format. The header format needs to be known for the mobile to be able to decode the header and hence the data.

In addition to the header, data, USF and stealing flag bits, a burst may also in some embodiments carry the Piggy backed Acknowledgement/Negative Acknowledgement (PAN) information. A PAN in downlink radio block indicates whether the radio blocks transmitted by a mobile device in the uplink have been received without errors by the network or not. Just like USF, the PAN could be in some embodiments be addressed to a different mobile than the data in the downlink radio block.

Tail bits 130 and 135 are added at the beginning of block 120 and end of block 125 respectively. Tail bits 130 and 135 are a known sequence of symbols and are used in some receiver implementations for certain signal processing steps. In the embodiment of FIG. 1, tails 130 and 135 are each 3 symbols.

Referring to FIG. 2, FIG. 2 shows the burst format for the EGPRS2-B burst format. EGPRS2-B uses a higher symbol rate than the GPRS/EGPRS/EGPRS2-A format. The symbol rate used in EGPRS2-B is 325 ksym/s whereas the symbol rate used in EGPRS2-A is 1625/6 ksym/s. Thus a burst 200 for EGPRS2-B is similar to a burst 100 from FIG. 1, with the exception that each section contains more symbols.

Referring to FIG. 2, TSC 210 of burst 200 comprises 31 symbols. The data+header+USF+stealing flag sections 220 and 225 contains 69 symbols. Tails 230 and 235 contain 4 symbols.

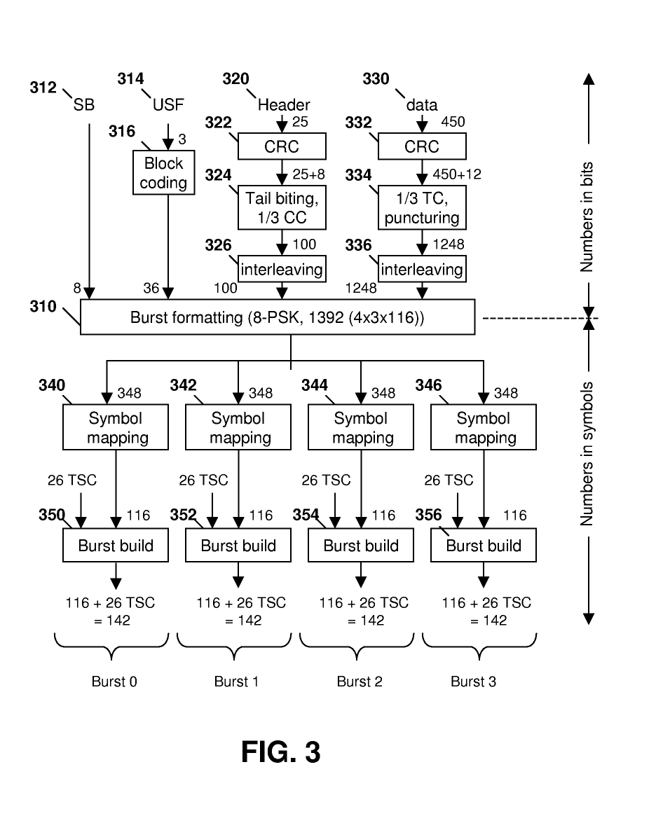

Reference is now made to FIG. 3 which shows the burst generation of DAS-5 in EGPRS2-A. The embodiment of FIG. 3 is meant to be exemplary and those skilled in the art having regard to the present disclosure would know how to adapt the burst generation for different coding and EGPRS2 formats.

In FIG. 3, a burst formatting block 310 receives 8 bits representing stealing bit flags 312.

Further, USF 314 provides 3 bits to a block coding block 316, which then provides 36 bits to burst formatting block 310.

A header 320 comprises 25 bits, which are provided to a cyclic redundancy check (CRC) block 322. The CRC adds 8 bits, therefore providing 33 symbols to a tail bitting and 1/3 rate convolution coding block 324. The result of the tail bitting and convolution coding block 324 is 100 bits, which are then interleaved at block 326 and provided to burst formatting block 310.

The data 330 provides 450 bits to a cyclic redundancy check block 332, which adds 12 symbols to the 450 resulting in 462 symbols. The 462 symbols are provided to 1/3 rate Turbo code followed by puncturing block 334. The result of block 334 is 1248 bits that are interleaved at block 336 and provided to burst formatting block 310.

The combination of all of the inputs at block 310 provides for 1392 bits, which are then divided into 4 bursts of 348 bits each. These bits are then input into four symbol mapping blocks 340, 342, 344 and 346. Each symbol mapping block maps 3 bits into 1 8-PSK symbol and hence outputs 116 8-PSK symbols.

Each of the symbol mapping block outputs a total of 116 symbols which are fed into a burst build block 350, 352, 354 and 356. In addition to the 116 symbols, each burst build block is also fed with 26 TSC symbols, resulting in a total of 142 symbols per burst, as shown in the burst of FIG. 1 (all bits except the tail bits in FIG. 1 are accounted for). As will be appreciated, the 4 bursts (burst0 to burst3) comprise 1 radio block and are pulse shaping filtered and transmitted over the air.

GPRS/EGPRS/EGPRS2 Compatibility

The decoding of the burst (FIG. 1 or FIG. 2) above, is done by receiving the training sequence bits and using the training sequence bits to estimate the channel conditions. The knowledge of the estimated channel is then used to undo the channel effects on the data portion 120, 125 in FIGS. 1 and 220 and 225 in FIG. 2.

Further, the TSC is known by both the transmitter and the receiver to allow for channel estimation.

According to the above, all mobile devices that are multiplexed may decode the USF in order to determine whether or not the mobile device is allocated to the next uplink radio block period.

However, not all mobile devices are capable of reading the USF from all different downlink modulations that are currently defined for GPRS/EGPRS/EGPRS2. Table 1 below shows the USF compatibility between various modulation formats and mobile device capabilities.

TABLE 1
post Rel-7 multiplexing situation
Capability of MS to Read the USF in a downlink radio block

| | | Modulation format of the downlink radio block | | | | | | |
|---|---|---|---|---|---|---|---|---|
| | | | | | | QPSK | 16QAM | 32QAM |
| | | GMSK | 8PSK | 16QAM | 32QAM | (HSR) | (HSR) | (HSR) |
| MS | GPRS | Yes | No | No | No | No | No | No |
| Capability | EGPRS | Yes | Yes | No | No | No | No | No |
| | EGPRS2A | Yes | Yes | Yes | Yes | No | No | No |
| | EGPRS2B | Yes | Yes | Yes | Yes | Yes | Yes | Yes |

As illustrated in Table 1, a GPRS mobile device is capable of receiving a USF from a burst that is modulated with GMSK, but is incapable of reading a burst modulated with 8PSK, 16 or 32 QAM, QPSK (HSR), 16 or 32 QAM (HSR).

An EGPRS device is capable of receiving a USF from a burst having GMSK and 8PSK, but not the rest.

An EGPRS2-A device is capable of receiving a USF from a burst having GMSK, 8PSK, 16 QAM and 32 QAM, but not the rest.

An EGPRS2-B device is capable of receiving a USF from burst with all of the above modulation schemes.

The inability of certain types of mobile devices to receive the USF in some downlink modulation schemes is a known problem in current EGPRS systems and has become more problematic with the interaction of new modulation schemes in EGPRS2 from release 7 onwards. The problem typically results in either segregation of network resources or reduction of throughput.

One solution to the above is to use a modulation scheme common to the mobile devices in the downlink radio block. Since GPRS, EGPRS and EGPRS2-A mobile devices have the same burst format and EGPRS2-A already includes GPRS and EGPRS modulation coding schemes, it is relatively easy to multiplex different types of mobile devices. However, using the common modulation scheme for burst may result in lowering the throughput for the mobile device to which data is addressed. For instance, data for an EGPRS2 device may need to be modulated with GMSK to allow a multiplexed GPRS device to be able to read a USF and this results in a significant drop in data throughput for the EGPRS2 device in question.

Moreover, since the burst format of EGPRS2-B is different from the burst format of the non-EGPRS2-B, due to the higher symbol rate, it is more difficult to multiplex EGPRS2-B mobile devices and non-EGPRS2-B mobile devices. The modulation coding scheme of the EGPRS2-B needs to fall back to the non-EGPRS2-B modulation coding scheme and this again may result in decreasing payload throughput.

It should also be noted that like USF, another piece of downlink data block that might be sent to a different mobile than the mobile to which the data is addressed to is the piggy-backed ACK/NACK block (PAN). The coding of the PAN block, like the coding of the USF block, is independent of the data and may be addressed to a different mobile device. The present disclosure is thus not limited to multiplexing for USF but is also applicable to other common signaling for one mobile that may be sent in a message that has data addressed to a different mobile.

Precoded EGPRS2

One ongoing study item in 3GPP GERAN is precoded ESPRS2 (PCE2), which was, for example, proposed in the 3GPP technical standards group and published in a paper by Telefon AB LM Ericsson, GP-101066 “Precoded EGPRS Downlink (Update of GP-100918)”, GERAN #46, May 17 to 21, 2010.

PCE2 is a new feature and aims to improve link level performance of EGPRS2. The gain in performance results in improved coverage and throughput by combating the negative effects of inter-symbol interference through the application of an inverse discrete Fourier transform (IDFT) precoding technique.

It is likely that two levels of PCE2 will be defined, as was done for EGPRS2. These levels will be referred to as PCE2-A and PCE2-B throughout the present disclosure. When used herein, PCE2 could refer to either or both of PCE2-A or PCE2-B. Like EGPRS2-A, PCE2-A uses the normal symbol rate and, like EGPRS2-B, PCE2-B uses a higher symbol rate. Compared to EGPRS2, PCE2 is expected to simplify the channel estimation and equalization procedures at the receiver and is expected to have a better performance, especially for higher order modulations. PCE2 may also reduce the receiver complexity. PCE2 is likely to preserve most of the channel coding details for the modulation and coding schemes (MCSs) specified in EGPRS2, except for DAS-12 and DBS-12.

Hereafter, the mobiles not supporting PCE2, i.e., GPRS, EGPRS, EGPRS2-A and EGPRS2-B mobiles are referred to as legacy mobiles.

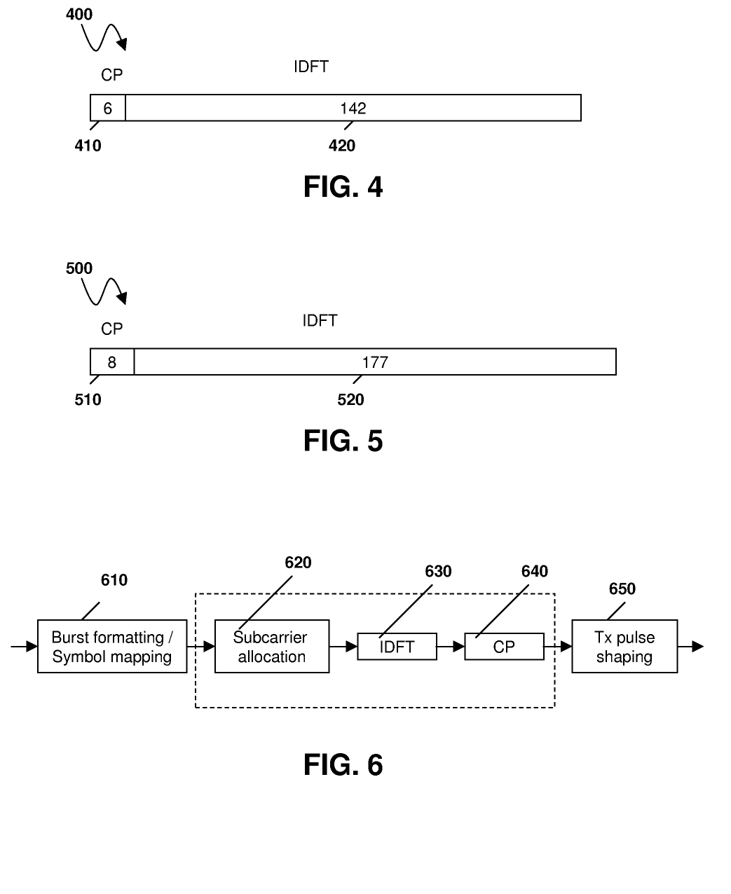

Reference is now made to FIG. 4, which shows the burst format for a PCE2-A burst. Burst 400 has a cyclic prefix 410 comprising 6 symbols, and a data portion 420 that utilizes IDFT and comprises 142 symbols. Compared to FIG. 1, it can be seen that the total number of symbols carried in a burst in FIG. 4 are the same as that in FIG. 1. The 2 tail symbol blocks 130 and 135 in FIG. 1 are now lumped into one cyclic prefix block of 6 symbols 410 in FIG. 4.

Similarly, referring to FIG. 5, a burst format for a PCE2-B burst is shown. Burst 500 contains a cyclic prefix 510 having 8 symbols, and a data portion 520 having 177 symbols. Compared to FIG. 2, it can be seen that the total number of symbols carried in a burst in FIG. 5 are the same as that in FIG. 2. The 2 tail symbol blocks 230 and 235 in FIG. 2 are now lumped into one cyclic prefix block of 8 symbols 510 in FIG. 5.

The IDFT precoding in bursts 400 and 500 results in a burst format similar to the well known orthogonal frequency divisional multiplexing (OFDM) technique. To mitigate the negative effect of inter-symbol interference on the IDFT precoded block, a cyclic prefix is appended to every IDFT (precoded) block. To achieve this, a number of symbols from the end of the IDFT precoded block are copied and arranged in front of that block. These copied symbols constitute the cyclic prefix.

Reference is made to FIG. 6, which shows a block diagram of a PCE2 transmitter. As seen in FIG. 6, the burst formatting and symbol mapping block 610 provides an output to a sub-carrier allocation block 620. Comparing FIG. 6 to FIG. 3, it can be noted that the burst formatting and symbol mapping blocks are common. The sub-carrier allocation block 620 in FIG. 6 is used to interleave the channel coded bits, which includes the data USF, SB, header, PAN and modulated training symbols.

The output from sub-carrier allocation block 620 is provided to IDFT block 630. After the inverse discrete Fourier transform is performed the output is sent to block 640, which adds the cyclic prefix.

After adding the cyclic prefix the signal is pulse shaped and transmitted, as shown by block 650.

Blocks 620, 630 and 640 are additional processes for PCE2 when compared with EGPRS2 above.

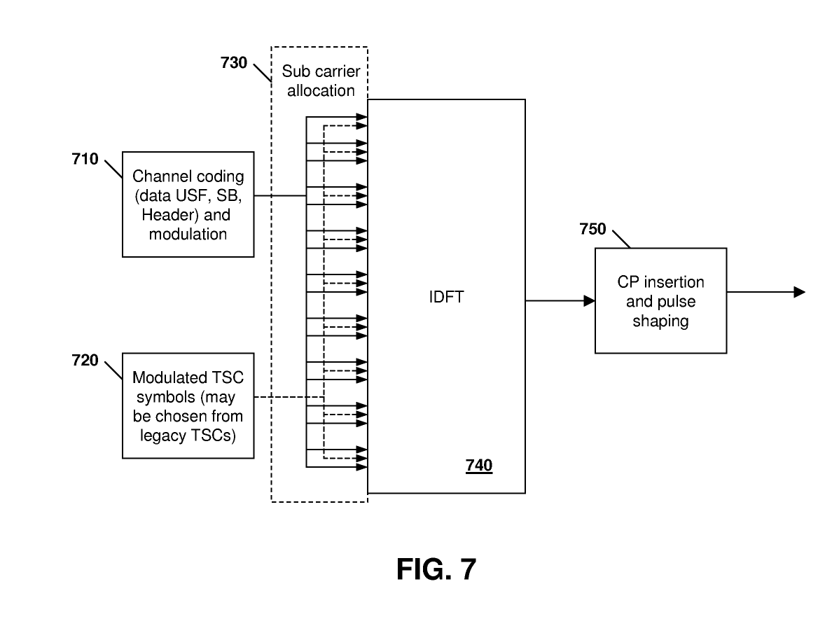

FIG. 7 shows how the modulated TSC symbols are mapped onto chosen pilot tones before the IDFT block. Specifically, the channel coding and modulation block 710 as well as a modulated TSC symbols block 720 are provided to sub-carrier allocation block 730.

The results of sub-carrier allocation block 730 are provided to IDFT block 740.

The output from block 740 is then provided to cyclic prefix insertion and pulse shipping block 750.

As will be appreciated by those in the art having regard to the above, before IDFT operation the symbols are essentially in the frequency domain. Hence, the TSC symbols are spread through the whole frequency band.

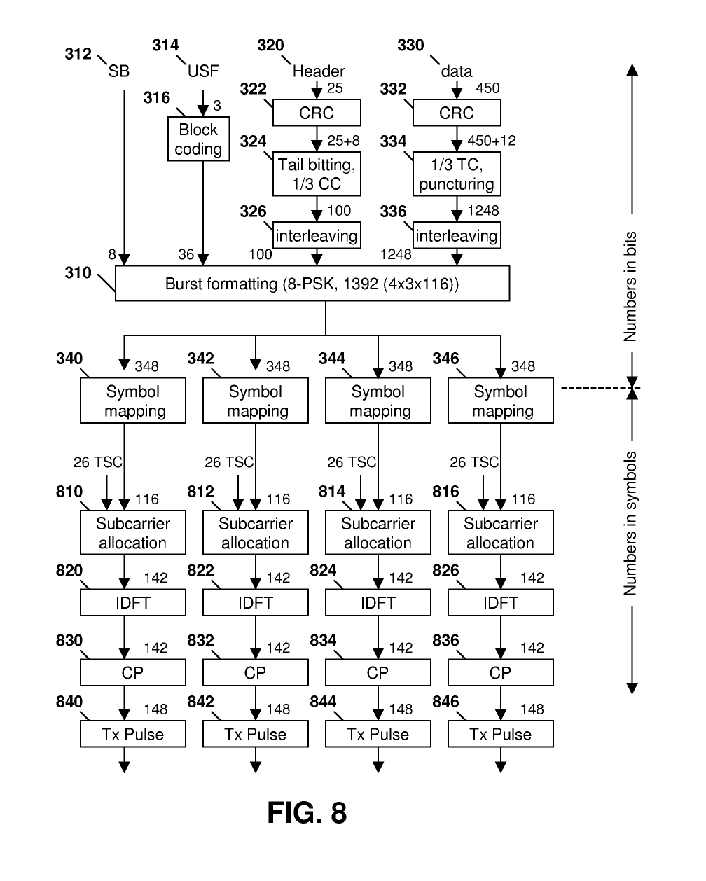

Reference is now made to FIG. 8, which shows a burst generator similar to that of FIG. 3 above. In particular, burst formatting 310 takes input bits from the stealing flag 312, USF 314 after block coding 316, header 320 after addition of cyclic redundancy check bits 322 followed by a tail biting convolutional coding of rate 1/3 324, the resulting 100 bits are then interleaved 326 to give 100 interleaved header bits.

Burst format 310 further takes input from the data bits 330 that are appended with cyclic redundancy check bits 332 followed by a 1/3 rate turbo coding 334. The output of the turbo coding block 334 is interleaved at block 336 before being provided to burst formatting block 310.

Symbol mapping occurs at blocks 340, 342, 344, and 346 and sub-carrier allocation blocks 810, 812, 814 and 816 are provided as the output from the symbol mapping.

From blocks 810, 812, 814 and 816, the outputs are then provided to IDFT blocks 820, 822, 824 and 826 respectively.

The cyclic prefix is then added at blocks 830, 832, 834 and 836.

The blocks are then pulse shaped at blocks 840, 842, 874 and 846 and transmitted.

At the receiver of a PCE2 mobile, the channel estimation is conducted in the frequency domain after a discrete Fourier transform (DFT) process.

In FIG. 4 and FIG. 5, assuming that the number of sub-carriers is symbolized as “n”, after IDFT precoding, n symbols are generated in the time domain, which are followed by the CP insertion. Thus, even if the training sequence symbols are chosen to be the legacy modulated TSC symbols that are currently used in EGPRS or EGPRS2, due to the IDFT precoding there are no legacy TSC symbols in the time domain in a PCE2 burst such as that shown in FIG. 4 or 5. This means that mobile devices which are not capable of PCE2 will be unable to decode bursts directed to a PCE2 device.

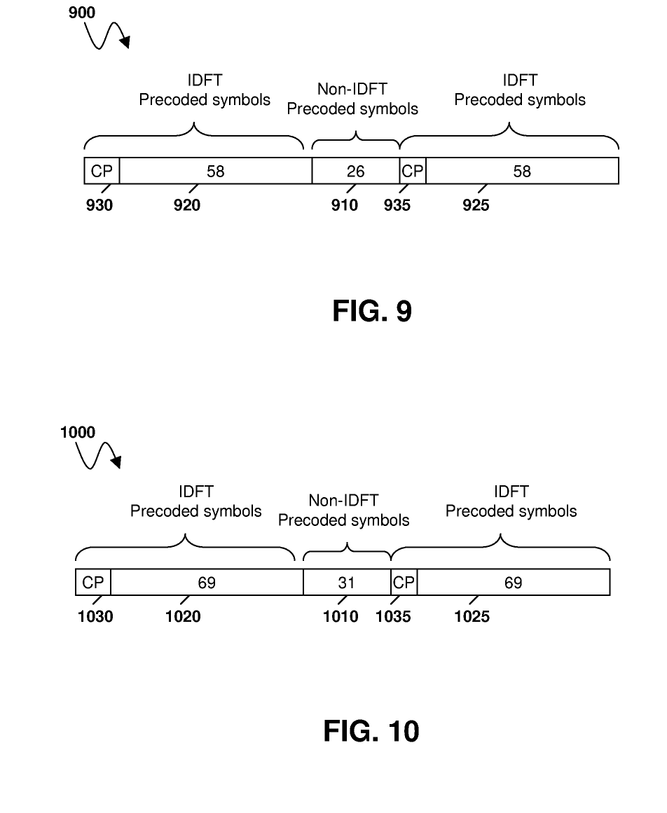

An alternative burst structure to the one shown above in FIGS. 4 and 5 can be seen below with regard to FIG. 9. FIG. 9 is based on a burst structure introduced at the 3GPP TSG-GERAN meeting #48, “On Burst Structure of Precoded EGPRS2” Motorola SAS, Nov. 22-26, 2010 which proposes adding a non-IDFT precoded section into the burst format for a PCE2 message. In particular, the proposed burst structure 900 includes a non-IDFT precoded TSC field 910 that has a 58 symbol IDFT field 920 and 58 symbol IDFT data field 925.

Cyclic prefixes 930 and 935 are provided before the IDFT fields 920 and 925 respectively.

The main advantage of having a burst structure such as that described in FIG. 9 is that the TSC field is in legacy format and hence legacy channel estimation and time frequency tracking mechanisms can be reused on the mobile. Additionally, sub-carrier spacing is also increased with the new burst structure thereby making the receiver more robust to Doppler shift and frequency drift errors.

Referring to FIG. 10, the figure shows the PCE2-B formatting for a burst 1000 in which the non-IDFT precoded TSC block 1010 comprises 31 symbols. Further, the IDFT blocks 1020 and 1025 comprise 69 symbols. The cyclic prefix 1030 and 1035 are added before the IDFT blocks 1020 and 1025 respectively.

As with the compatibility issues for GPRS/EGPRS/EGPRS2, PCE2 creates further legacy compatibility issues.

In order to multiplex PCE2 mobile devices with non-PCE2 mobile devices in the downlink TBF, one proposal is to use the same mechanism for multiplexing EGPRS2-B mobile devices and non-EGPRS2-B mobile devices. In other words, the multiplexing scheme would fall back to the burst format for GPRS/EGPRS devices when the PCE2 mobile device is multiplexed with such a legacy device. However, this throughput for PCE2 mobile devices. On the other hand, if the network uses a PCE2 burst format to maximize the throughput for PCE2 devices, legacy no PCE2 mobile devices may miss preferred scheduling opportunities for uplink since USF can not be sent to these mobiles in PCE2 downlink blocks.

Referring to Table 2, the table shows the capability of a mobile station to read USF in the downlink radio block after PCE2-A and PCE2-B have been added. As shown, no legacy mobile device is able to read PCE2-A or B modulated bursts. Hence, the PCE2 burst is completely incompatible with legacy GPRS, EGPRS and EGPRS2 mobile devices resulting in the problem that with the PCE2 radio block format in downlink, USF multiplexing of PCE2 mobile devices and non-PCE2 mobile devices is not feasible.

TABLE 2
multiplexing situation with PCE2
Capability of MS to Read the USF in a downlink radio block

| | | Modulation format of the downlink radio block | | | | | | | | |
|---|---|---|---|---|---|---|---|---|---|---|
| | | | | | | QPSK | 16QAM | 32QAM | | |
| | | GMSK | 8PSK | 16QAM | 32QAM | (HSR) | (HSR) | (HSR) | PCE2 A | PCE2 B |
| MS Capability | GPRS | Yes | No | No | No | No | No | No | No | No |
| | EGPRS | Yes | Yes | No | No | No | No | No | No | No |
| | EGPRS2A | Yes | Yes | Yes | Yes | No | No | No | No | No |
| | EGPRS2B | Yes | Yes | Yes | Yes | Yes | Yes | Yes | No | No |
| | PCE2-A | Yes | Possibly | Possibly | Possibly | Possibly | Possibly | Possibly | Yes | No |
| | | | yes | yes | yes | No | No | No | | |
| | PCE2-B | Yes | Possibly | Possibly | Possibly | Possibly | Possibly | Possibly | Yes | Yes |
| | | | yes | yes | yes | yes | yes | yes | | |

Further, if a legacy mobile device does not detect a reliable training sequence in the mid-amble of the burst, it is unlikely to make a USF detection attempt on such burst. This is because there are strict false detection constraints for USF detection for legacy mobile devices, as described in the Third Generation Partnership Project, “Radio Transmission and Reception”, Technical Specification 45.005 v. 9.5.0, Dec. 21, 2010, the contents of which are incorporated herein by reference.

Normally, if a burst is detected as too noisy, which would be the case if the legacy mobile device attempted to decode a PCE2 burst, the legacy mobile will ignore the USF field in such a burst to satisfy the USF false detection requirements. Hence with the introduction of PCE2, the problem highlighted in Table 1 above becomes more severe, as shown by Table 2.

In accordance with the present disclosure, one way to support the multiplexing of legacy mobile devices while adopting the PCE2 burst format (to send data to a PCE2 capable mobile device) is to maintain the non IDFT precoded parts of the downlink data that are also needed to be read by the legacy mobiles using the same format as used in legacy bursts. Thus various parts of the legacy bursts should be keep in legacy format and may include the TSC, the symbols carrying the USF, the symbols carrying PAN information, and tail symbols as per legacy burst format. All or some of the above can be kept in legacy format in a burst directed to be read by legacy devices. By keeping some or all of these fields in legacy format, it may be ensured that parts can be decoded by legacy mobile devices in the field while other parts of the burst can then be encoded in precoded format, thereby improving the performance of the data in these parts of the burst.

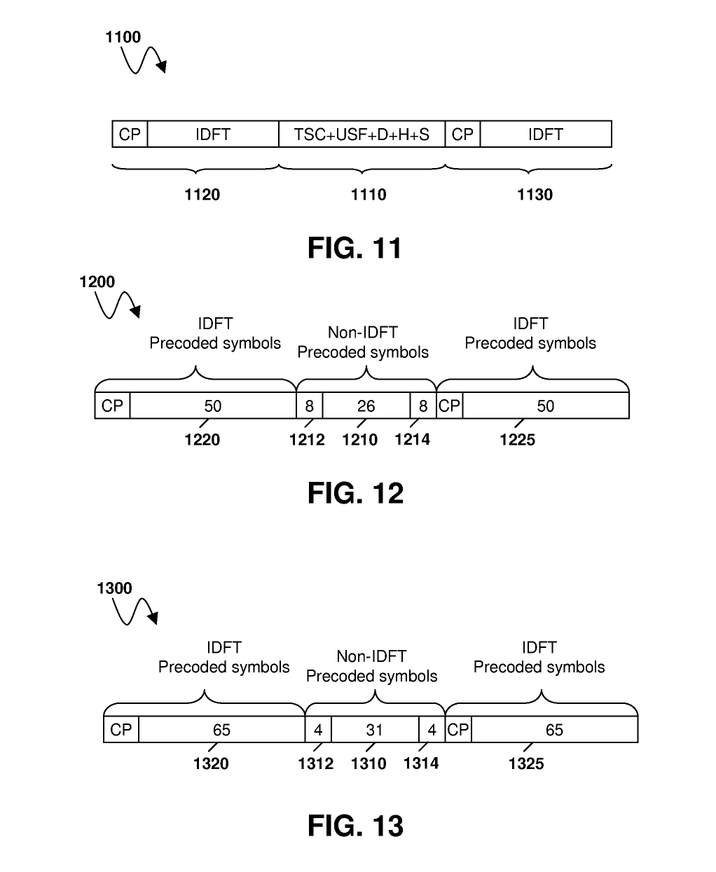

Reference is now made to FIG. 11. Instead of a single IDFT precoded block for each PCE2 burst, one alternative to multiplex the PCE2 mobile device and non-PCE2 mobile device is to use a new burst format for PCE2 as described below. As shown in FIG. 11, the PCE2 burst is segmented into three sections. In the middle section 1110, as used in GPRS/EGPRS/EGPRS2, the TSC symbols of PCE2 will be unchanged. This matches the mid-amble for legacy GPRS, EGPRS and EGPRS2 systems for any modulation supported by these mobiles, as shown above with regard to FIGS. 1 and 2. The symbols including USF bits and other symbols originally arranged around the TSC which may carry information related to the USF and/or PAN are also kept unchanged as in the EGPRS2 burst build. In fact on either side of the TSC, all the symbols till the farthest symbol from TSC carrying USF and/or PAN information are kept in legacy format such that they can be decoded by non PCE2 mobiles. Such a legacy format section is referred to herein as a non-IDFT precoded part.

Sections 1120 and 1130 of the burst are created through IDFT precoding followed by CP insertion.

In block 1110 above, the section of the burst that is indicated as TSC+USF+D+H+S may include some data symbols, all USF symbols, PAN symbols and some header symbols.

FIG. 11 is the basic template that will be used for various burst structures for PCE2. Specific burst structures for PCE2-A and PCE2-B can be derived from this general template in FIG. 11. Based on the above, reference is now made to FIGS. 12 and 13. In FIG. 12, a burst format 1200 for PCE2-A is shown. Similarly, FIG. 13 shows a burst format 1300 for PCE2-B.

As shown in FIG. 12, a total of 42 symbols in the middle of the burst are coded such that they carry the symbols in a format which the legacy GPRS/EGPRS/EGPRS2 mobiles can decode these symbols. These non-IDFT precoded 42 symbols include the 26 TSC symbols 1210. On either side of section 1210, symbols carrying all the data bits related to USF and some data symbols 1212 and 1214 are provided. On either side of the TSC, all the symbols until the farthest symbol from TSC carrying USF information are kept in legacy format such that they can be decoded by non PCE2 mobiles. In this embodiment, 8 symbols on either side of the TSC are sufficient to convey all the USF information to legacy mobiles irrespective of the modulation scheme used for the PCE2 burst. However, this is not meant to be limiting and other numbers of symbols could be used.

Sections 1220 and 1225 provide the IDFT precoded symbols along with the cyclic prefix. In the example of FIG. 12, the IDFT section includes 50 symbols.

The cyclic prefix length is 3 in the example of FIGS. 12 and 4 for the example of FIG. 13. This may be sufficient in most scenarios However, if the cyclic prefix length is not sufficient, longer cyclic prefix lengths can be used and the IDFT part of the burst is shortened accordingly.

In FIG. 13, a 31 symbol TSC 1310 is surrounded by two sections 1312 and 1314, which contain 4 symbols each. The 4 symbols in sections 1312 and 1314 fully constitute the USF bits transmitted in the downlink.

FIG. 13 further includes 65 symbols for the IDFT in sections 1320 and 1325 and a cyclic prefix is further provided.

As will be appreciated by those in the art having regard to the above, the burst formats shown in FIG. 12 and FIG. 13 allow the legacy GPRS/EGPRS/EGPRS2 mobile device to acquire full knowledge of the channel due to the presence of the legacy TSC and the legacy mobile device can thus proceed to decode the USF from this burst format provided the legacy mobile in question is capable of reading this modulation used as shown in Table 1.

Referring to Tables 3 to 5 below, these tables show PCE2-A burst formatting for various modulations.

For 8-PSK modulation, Table 3 shows the PCE2-A burst format.

TABLE 3
PCE2-A burst for 8-PSK

| Bit | Length | | Definition |
|---|---|---|---|
| Number | in Bits | Contents of Field | (3GPP TS) |
| 0-8 | 9 | Cyclic prefix (generated after | 45.004 |
| | | IDFT) | |
| 9-158 | 150 | IDFT preceded encrypted bits | 45.003 |
| | | (e0.e149) | |
| 159-183 | 24 | Encrypted bits (e150.e173) | 45.003 |
| 183-260 | 78 | Training sequence bits | 45.002, |
| | | | subclause 5.2.3, |
| | | | normal burst for |
| | | | 8PSK |
| 261-284 | 24 | Encrypted bits (e174.e197) | 45.003 |
| 285-293 | 9 | Cyclic prefix (generated after | 45.004 |
| | | IDFT) | |
| 294-443 | 150 | IDFT preceded encrypted bits | 45.003 |
| | | (e198.e347) | |
| 444-468 | 24.75 | Guard period | 45.002 subclause |
| | | | 5.2.8 |

For 16-QAM modulation, Table 4 shows the PCE2-A burst format.

TABLE 4
PCE2-A burst for 16-QAM

| Bit | Length | | Definition |
|---|---|---|---|
| Number | in Bits | Contents of Field | (3GPP TS) |
| 0-11 | 12 | Cyclic prefix (generated after | 45.004 |
| | | IDFT) | |
| 12-211 | 200 | IDFT preceded encrypted bits | 45.003 |
| | | (e0.e199) | |
| 212-243 | 32 | Encrypted bits (e200.e231) | 45.003 |
| 244-347 | 104 | Training sequence bits | 45.002, |
| | | | subclause 5.2.3, |
| | | | normal burst for |
| | | | 16-QAM |
| 348-379 | 32 | Encrypted bits (e200.e231) | 45.003 |
| 380-391 | 12 | Cyclic prefix (generated after | 45.004 |
| | | IDFT) | |
| 392-591 | 200 | IDFT preceded encrypted bits | 45.003 |
| | | (e232.e463) | |
| 592-624 | 33 | Guard period | 45.002 subclause |
| | | | 5.2.8 |

For 32-QAM modulation, Table 5 shows the PCE2-A burst format.

TABLE 5
PCE2-A burst for 32-QAM

| Bit | Length | | Definition |
|---|---|---|---|
| Number | in Bits | Contents of Field | (3GPP TS) |
| 0-14 | 15 | Cyclic prefix (generated after | 45.004 |
| | | IDFT) | |
| 15-264 | 250 | IDFT preceded encrypted bits | 45.003 |
| | | (e0.e249) | |
| 265-304 | 40 | Encrypted bits (e250.e289) | 45.003 |
| 305-434 | 130 | Training sequence bits | 45.002, |
| | | | subclause 5.2.3, |
| | | | normal burst for |
| | | | 32-QAM |
| 435-474 | 40 | Encrypted bits (e289.e329) | 45.003 |
| 475-489 | 15 | Cyclic prefix (generated after | 45.004 |
| | | IDFT) | |
| 490-739 | 250 | IDFT preceded encrypted bits | 45.003 |
| | | (e330.e579) | |
| 740-781 | 41.25 | Guard period | 45.002 subclause |
| | | | 5.2.8 |

Referring to Tables 6 to 8 below, these tables show PCE2-B burst formatting for various modulations.

For QPSK modulation, Table 6 shows the PCE2-B burst format.

TABLE 6
PCE2-B burst for QPSK

| Bit | Length | | Definition |
|---|---|---|---|
| Number | in Bits | Contents of Field | (3GPP TS) |
| 0-7 | 8 | Cyclic prefix (generated after | 45.004 |
| | | IDFT) | |
| 8-137 | 130 | IDFT preceded encrypted bits | 45.003 |
| | | (e0.e129) | |
| 138-145 | 8 | Encrypted bits (e130.e137) | 45.003 |
| 146-207 | 62 | Training sequence bits | 45.002, |
| | | | subclause 5.2.3a, |
| | | | higher symbol rats |
| | | | burst for QPSK |
| 208-215 | 8 | Encrypted bits (e138.e145) | 45.003 |
| 216-223 | 8 | Cyclic prefix (generated after | 45.004 |
| | | IDFT) | |
| 224-353 | 130 | IDFT preceded encrypted bits | 45.003 |
| | | (e146.e275) | |
| 354-374 | 21 | Guard period | 45.002 subclause |
| | | | 5.2.8 |

For 16-QAM modulation, Table 7 shows the PCE2-B burst format.

TABLE 7
PCE2-B burst for 16-QAM

| Bit | Length | | Definition |
|---|---|---|---|
| Number | in Bits | Contents of Field | (3GPP TS) |
| 0-15 | 16 | Cyclic prefix (generated after | 45.004 |
| | | IDFT) | |
| 16-275 | 260 | IDFT preceded encrypted bits | 45.003 |
| | | (e0.e259) | |
| 276-291 | 16 | Encrypted bits (e260.e275) | 45.003 |
| 292-415 | 124 | Training sequence bits | 45.002, |
| | | | subclause 5.2.3a, |
| | | | higher symbol rats |
| | | | burst for 16QAM |
| 416-431 | 16 | Encrypted bits (e276.e291) | 45.003 |
| 432-447 | 16 | Cyclic prefix (generated after | 45.004 |
| | | IDFT) | |
| 448-707 | 260 | IDFT preceded encrypted bits | 45.003 |
| | | (e292.e551) | |
| 708-749 | 42 | Guard period | 45.002 subclause |
| | | | 5.2.8 |

For 32-QAM modulation, Table 8 shows the PCE2-B burst format.

TABLE 8
PCE2-B burst for 32-QAM

| Bit | Length | | Definition |
|---|---|---|---|
| Number | in Bits | Contents of Field | (3GPP TS) |
| 0-19 | 20 | Cyclic prefix (generated after | 45.004 |
| | | IDFT) | |
| 20-344 | 325 | IDFT preceded encrypted bits | 45.003 |
| | | (e0.e324) | |
| 345-364 | 20 | Encrypted bits (e325.e344) | 45.003 |
| 365-519 | 155 | Training sequence bits | 45.002, |
| | | | subclause 5.2.3a, |
| | | | higher symbol rats |
| | | | burst for 32QAM |
| 520-539 | 20 | Encrypted bits (e345.e364) | 45.003 |
| 540-559 | 20 | Cyclic prefix (generated after | 45.004 |
| | | IDFT) | |
| 560-884 | 325 | IDFT preceded encrypted bits | 45.003 |
| | | (e365.e689) | |
| 885-937 | 52.5 | Guard period | 45.002 subclause |
| | | | 5.2.8 |

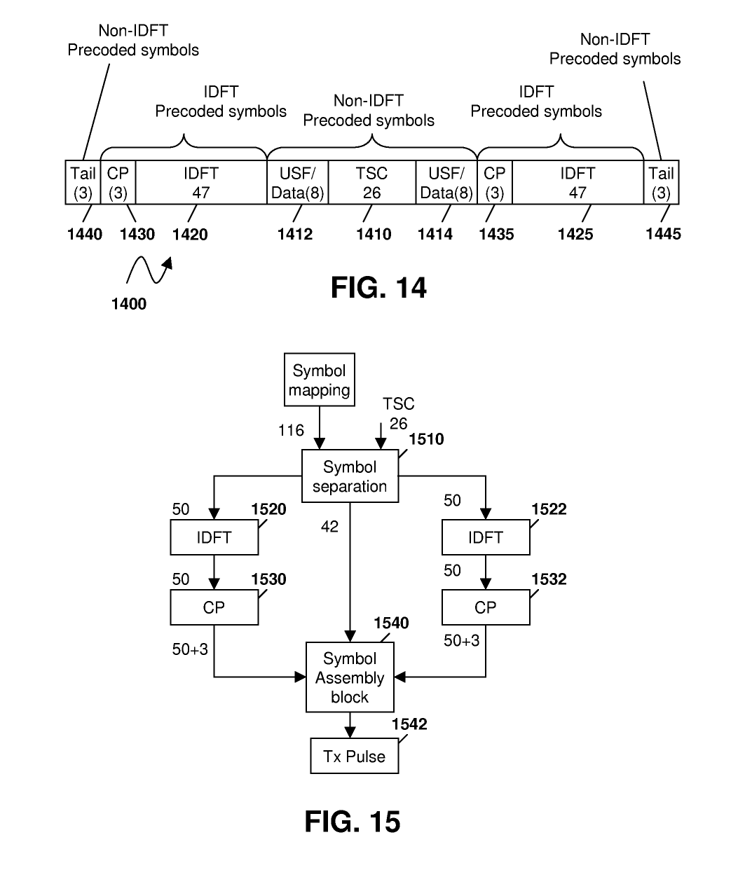

Reference is now made to FIG. 14. In some legacy mobile devices, the device may also need to know tail bits for some signal processing steps, including any or all of trellis termination, frequency offset estimation and correlation, among others. In this case, the possible new burst format might need to accommodate the legacy tail symbols as they are. In this case, the format of FIG. 14 is used with the PCE2-A format. A similar format may be used for the PCE2-B burst format in which IDFT symbols are removed in order to accommodate a tail portion.

In particular, the burst format 1400 of FIG. 14 includes a TSC 1410 which is surrounded by 8 symbols representing the USF, shown by sections 1412 and 1414.

The IDFT in the example of FIG. 14 has 47 symbols shown by sections 1420 and 1425.

A cyclic prefix 1430 includes 3 symbols. Similarly, cyclic prefix 1435 also includes 3 symbols.

In the embodiment of FIG. 14, a tail 1440 and tail symbols 1445 are added at the ends of the bursts symbol. The tail symbols in the example of FIG. 14 includes 3 symbols.

TSC 1410, USF sections 1412 and 1414, and tails 1440 and 1445 are modulated and transmitted in non-IDFT precoded legacy format such that they can be decoded by a GPRS/EGPRS/EGPRS2 mobile.

In general, further legacy fields could be included as needed for any legacy signaling processing purposes by shortening the IDFT part of the new burst structure.

Referring to FIG. 15, the figure shows a block diagram describing a method for generating a precoded burst in accordance with FIG. 12. The example of FIG. 15 could further be applied to the bursts of FIGS. 11, 13 and 14 with minor changes.

As a result of symbol mapping, for example from block 710 of FIG. 7 or 340 from FIG. 3, the output is provided to a symbol separation block 1510.

Symbol separation block 1510 takes the 116 data symbols, along with the 26 symbol TSC. Symbol separation block 1510 provides 50 symbols to IDFT block 1520 and 50 symbols to IDFT block 1522.

From blocks 1520 and 1522 a cyclic prefix is added in blocks 1530 and 1532 respectively.

The output from block 1530 and 1532, along with an additional 42 symbols from the symbol separation block including the 26 TSC symbols and 16 symbols which will be mapped on either side of the TSC symbols, are then provided to a symbol assembly block 1540 which will then put together to form the burst as shown in FIG. 12. This block is then input to the pulse shaping block 1542.

As will be appreciated by those skilled in the art having regard to the present disclosure, FIG. 15 shows the example of FIG. 12 being encoded for burst. In other embodiments, different numbers of symbols may be provided to IDFT block 1520 and 1522 and a different number of symbols may be provided from symbol separation block 1510 to symbol assembly block 1540, depending on the number of symbols needed to be provided in the non-IDFT precoded legacy format.

The input to the transmit pulse shaping block block 1542 is a burst similar to that shown in FIG. 12.

PCE2 Encoded Payload Symbols

It can be observed from the burst format in FIG. 12 that a PCE2 mobile device will need to process both the symbols in blocks 1212 and 1214 around the TSC in the legacy fashion using the legacy equalization methods as well as processing the IDFT precoded parts of the burst 1220 and 1225 using the known frequency domain equalization techniques for OFDM. Requiring both a legacy processing functionality to decode the symbols around the TSC and a new equalizer functionality to decode the rest of the burst may increase the complexity of a PCE2 mobile device. In a further embodiment, in order to decrease receiver complexity, full payload symbols may be provided in the IDFT precoded parts of a burst message to allow such payload symbols to be decoded in the frequency domain by a PCE2 mobile device. In order to achieve this, all the information contained in the payload symbols transmitted around the TSC in non-IDFT parts of the new burst format are duplicated into the IDFT precoded part of the burst.

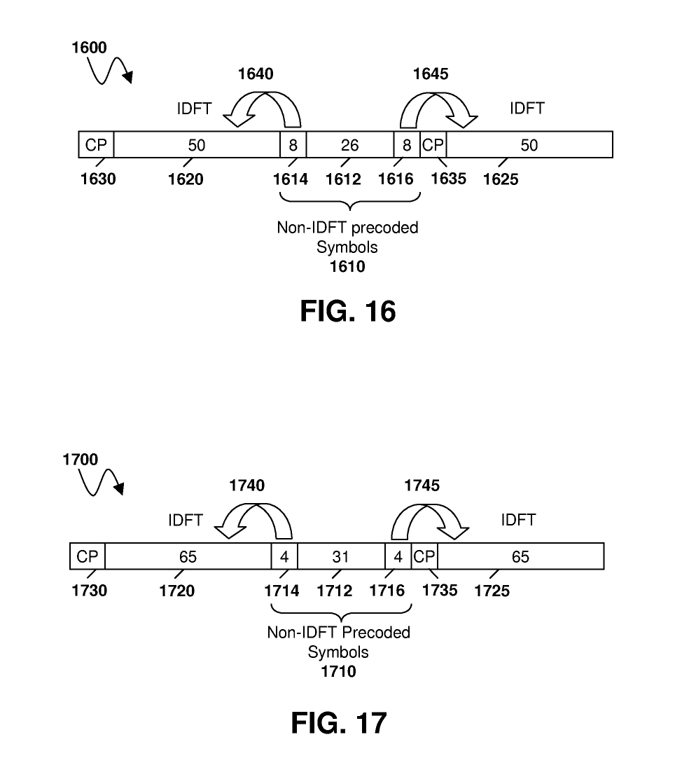

Reference is now made to FIG. 16, which shows a burst 1600. The non-IDFT precoded part 1610 of burst 1600 includes a 26 symbol TSC 1612, the UFS/data sections 1614 and 1616, which comprise 8 symbols, and the IDFT portions 1620 and 1625. Each of IDFT portions 1620 and 1625 have an associated cyclic prefix 1630 and 1635 respectively.

Arrows 1640 and 1645 represent the duplication of the symbols at sections 1614 and 1616 into IDFT blocks 1620 and 1625 respectively.

Thus, a PCE2 receiver receiving burst 1600 does not need to decode the non-IDFT precoded part to obtain USF or PAN information, but can simply decode the information in the IDFT precoded part.

FIG. 17 similarly shows the PCE2-B burst 1700 in which the time domain component 1710 includes TSC 1712 along with the USF portion 1714 and 1716. In the case of FIG. 17, the TSC 1712 includes 31 symbols and the USF components 1714 and 1716 contain 4 symbols respectively.

The IDFT portions 1720 and 1725 in FIG. 17 contain 65 symbols each. Further, the cyclic prefixes 1730 and 1735 are located before IDFT portions 1720 and 1725 respectively.

Arrows 1740 and 1745 represent sections 1714 and 1716 being placed into the IDFT portions 1720 and 1725 respectively.

The embodiments shown in FIGS. 16 and 17 allow for a PCE2 mobile device to use only the IDFT precoded part to retrieve full information from the burst. The addition of the USF symbols into the IDFT precoded part however does cause a slight decrease in the throughput for data since part of the data portion is consumed by the repeated USF information.

As will be appreciated by those in the art having regard to the above, the number of symbols in the IDFT blocks occupied by the copied time domain symbols depends on the modulation formats used in the IDFT part of the payload.

Switching Between Pure and Legacy Compatible PCE2

In one embodiment, the burst format could be signaled to a receiver prior to sending the burst. For example, a PC-EGPRS2 information element could be used to signal the burst. Such information element is shown in Table 9 below.

TABLE 9
EGPRS Level information element details

| EGPRS Level | PC- | |
|---|---|---|
| information | EGPRS | |
| element | Level | value |
| bits | bit | |
| 2 1 | 1 | |
| 0 0 | 0 | EGPRS |
| 0 0 | 1 | EGPRS |
| 0 1 | 0 | PCE2-A: using normal burst with |
| | | legacy compatibility for PCE2 (NB2- |
| | | PCE2 see 3GPP TS 45.001) |
| 0 1 | 1 | PCE2-A: using normal burst pure |
| | | PCE2 for PCE2 (NB1-PCE2) |
| 1 0 | 0 | PCE2-B: using higher symbol rate |
| | | burst with legacy compatibility for |
| | | PCE2 (HB2-PCE2) |
| 1 0 | 1 | PCE2-B: using higher symbol rate |
| | | burst pure PCE2 for PCE2 (HB1- |
| | | PCE2) |
| 1 1 | 0 | reserved |
| 1 1 | 1 | reserved |

In a further embodiment, a check could be made at the network to determine whether or not there are legacy mobile devices multiplexed with PCE2 mobile devices in a temporary block flow. From the above, the burst formats of FIGS. 4, 5, 9 and 10 may be considered to be pure PCE2 bursts, and the burst formats of FIGS. 11, 12, 13, 14, 16 and 17 could be considered to be legacy compatible PCE2 bursts.

In this embodiment, the check could determine whether or not such legacy mobile devices are multiplexed and if not, a pure PCE2 burst format could be utilized in which no time domain symbols are provided at all. In such a case, the information regarding the USF and/or the PAN is encoded in the IDFT precoded portion, as no time domain symbols for legacy purposes are required. In this case, either the bursts shown in FIG. 4 and FIG. 5 or the burst shown in FIG. 9 and FIG. 10 above can be utilized.

Conversely, if legacy mobile devices are multiplexed with PCE2 mobile devices in the TBF, the bursts of FIG. 11-14, or 16 or 17 could be utilized.

In one embodiment, two options exist with regard to when to switch between pure PCE2 and legacy compatible PCE2 bursts. One option is to switch at the TBF setup. The network could allocate a TBF in pure PCE2 mode if there are no legacy mobile devices multiplexed on that time slot. For example, if either the network segregates the resources or if there are no non-PCE2 mobiles in the field then at TBF setup time, then pure PCE2 bursts as shown in FIG. 4 and FIG. 5 or FIG. 9 and FIG. 10 could be used.

A second option is to dynamically switch the burst mode during the call. In this case, if the data USF and PAN in a given downlink radio block are all addressed to PCE2 mobile devices then the network uses the burst structures shown in FIGS. 4 and 5 or FIG. 9 and FIG. 10 above. Conversely, if the data is addressed to the PCE2 mobiles but the USF and PAN are addressed to a legacy mobile device, then the network uses the burst structure detailed in FIG. 11-14, 16 or 17 above. In this option the PCE2 mobile device needs to blindly detect the burst used by the network.

In order to decode the burst, the PCE2 mobile needs to blindly detect the burst used by the network. The first option for blind detection includes hypothesizing both burst modes, attempting the decoding of the burst header for both hypotheses and accepting a hypotheses if the CRC check on the header passes.

A second possible option for blind detection includes hypothesizing both burst modes, performing decoding of the USF for both hypotheses and accepting the hypothesis that results in the least noisy decoded USF codeword.

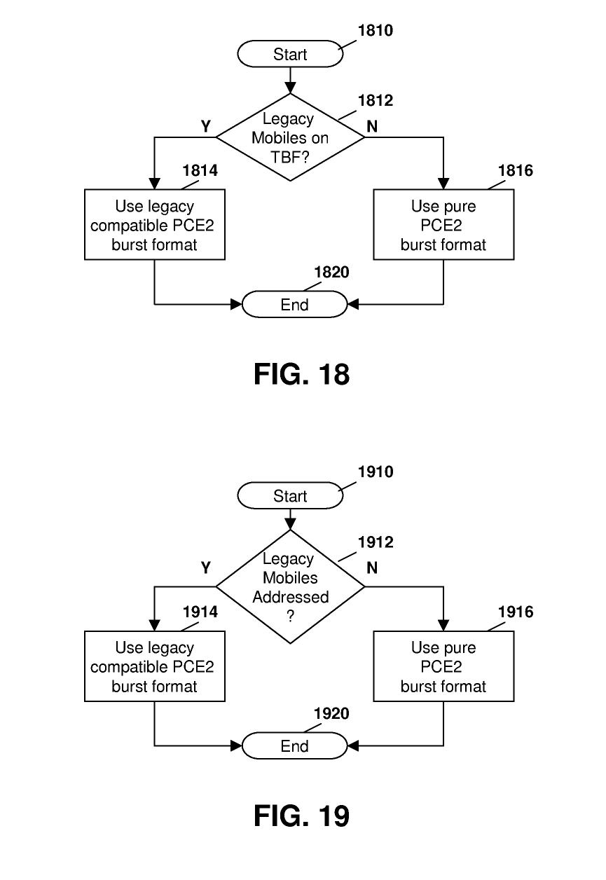

Reference is now made to FIG. 18, which shows a method for allocating a PCE2 burst structure at TBF setup. The process of FIG. 18 starts at block 1810 and proceeds to block 1812 in which a check is made to determine whether or not there are legacy mobile devices on the TBF.

If the check of block 1812 finds legacy mobile devices in the TBF, the process proceeds to block 1814 in which use of a legacy compatible PCE2 burst is allocated. Conversely, if the check at block 1812 determines that there are no legacy mobile devices on the TBF, the process proceeds to block 1816 and the use a pure PCE2 burst is allocated.

From blocks 1814 and 1816 the process proceeds to block 1820 and ends.

When the burst format is allocated based on recipients, a process such as that described in FIG. 19 could be used.

Referring to FIG. 19, the process starts at block 1910 and proceeds to block 1912. In block 1912, a check is made to determine whether a particular burst is addressed to a legacy mobile device. As will be appreciated by those in the art having regard to the above, the data portion, USF portion, or both could be addressed to a legacy mobile device.

If any of the burst is addressed to a legacy mobile, the process proceeds to block 1914 and allocates a legacy compatible PCE2 burst format. Conversely, if none of the burst is addressed to a legacy mobile device the process proceeds from block 1912 to block 1916 in which a pure PCE2 burst format is allocated.

The process then proceeds from blocks 1914 and 1916 to block 1920 and ends.

On the receiver, various techniques can be used to decode the burst. In one embodiment, signaling can occur between the mobile device and network regarding the burst to be used. For example, a single bit or a plurality of bits could be used to indicate to the mobile device that a certain burst format will be used on the TBF.

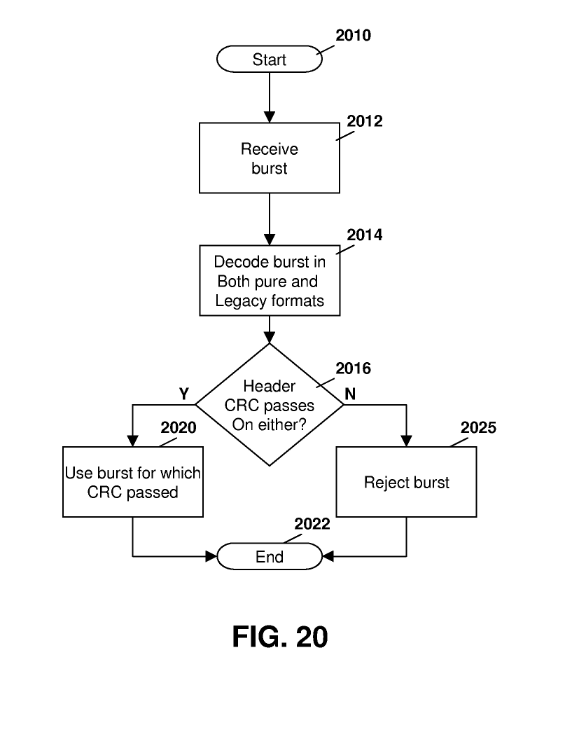

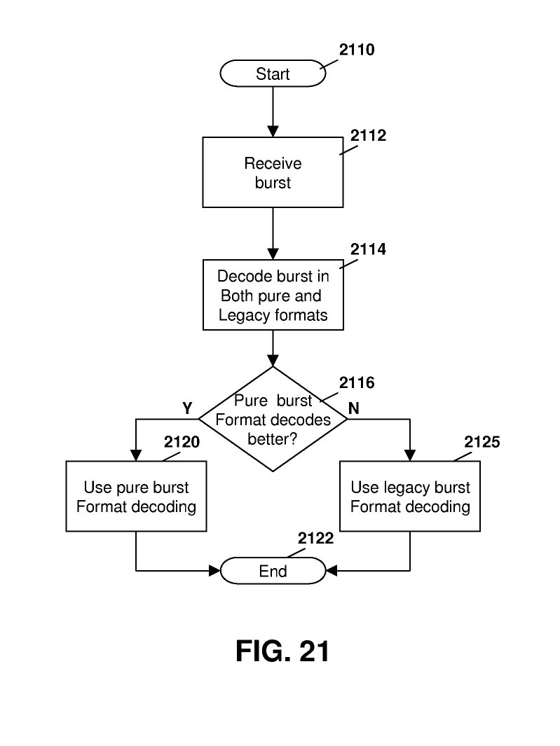

Alternatively, the mobile device may try using multiple burst formats for decoding. FIGS. 20 and 21 show the use of two burst formats but could be expanded to more than two.

Reference is now made to FIG. 20 in which the process starts at block 2010 and proceeds to block 2012 where a burst is received.

The process then proceeds to block 2014 in which the burst is decoded using both pure and legacy PCE2 burst formats.

The process then proceeds to block 2016 and checks the CRC on the header for the two decoded bursts. If one of the cyclic redundancy checks passes, the process proceeds to block 2020 and accepts the burst for which the header CRC passed and uses this burst format to process the rest of the data in the burst. The process then proceeds to block 2022 and ends.

Conversely, if the check of block 2016 does not find a CRC match for either burst, the process proceeds to block 2025 and rejects both bursts and proceeds to block 2022 and ends.

Alternatively, the receiver could utilize a check to determine which burst decoding provides a better result. Reference is now made to FIG. 21, in which the process starts at block 2110 and proceeds to block 2112 in which a burst is received.

The process then proceeds to block 2114 and decodes the burst using both pure and legacy burst formats.

The process then proceeds to block 2016 and checks to see whether the first decoded message (using the pure legacy format) has a less noisy USF than the second decoding. If yes the process proceeds to block 2120 and accepts the first decoded burst. Conversely, the process will proceed from block 2016 to block 2122 and accept the second burst if the second burst is less noisy.

The process then proceeds from blocks 2120 and 2122 to block 2124 and ends.

The above therefore provides for a burst format for PCE2 mobiles which uses both IDFT precoded and non-IDFT precoded parts in a PCE2 burst to allow a legacy mobile device to decode portions of the burst directed at the legacy mobile device. Such portions can include USF information, PAN information, tail bits, among others.

In one embodiment the USF and other portions can also be placed in the IDFT precoded portion.

A receiver may decode using both legacy compatible and pure PCE2 burst formats and either discard a message if the CRC does not match or use the less noisy USF portion.

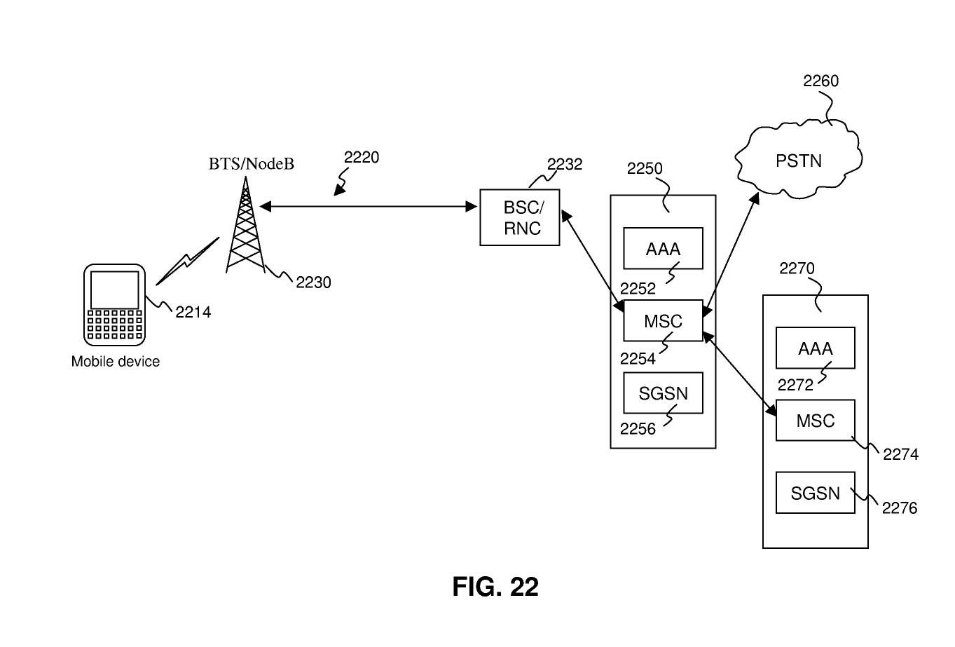

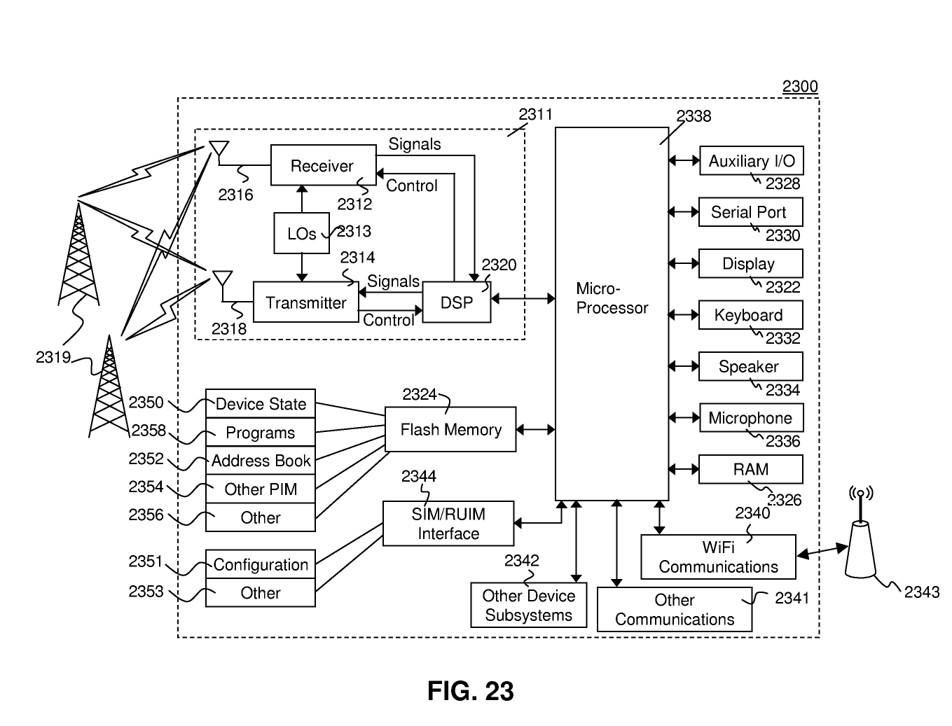

The methods and coding of FIGS. 1 to 21, can be performed by any network element. As used herein, a network element can be a network side server or a mobile device. Reference is now made to FIGS. 22 and 23, which show exemplary network and mobile device architectures.

FIG. 22 illustrates an architectural overview for an exemplary network. A mobile device 2214 is configured to communicate with cellular network 2220.

Mobile device 2214 may connect through cellular network 2220 to provide either voice or data services. As will be appreciated, various cellular networks exist, including, but not limited to, global system for mobile communication (GSM), GPRS, EGPRS, EGPRS2, among others. These technologies allow the use of voice, data or both at one time.

Cellular network 2220 comprises a base transceiver station (BTS)/Node B 2230 which communicates with a base station controller (BSC)/Radio Network Controller (RNC) 2232. BSC/RNC 2232 can access the mobile core network 2250 through either the mobile switching center (MSC) 2254 or the serving GPRS switching node (SGSN) 2256. MSC 2254 is utilized for circuit switched calls and SGSN 2256 is utilized for data packet transfer. As will be appreciated, these elements are GSM/UMTS specific, but similar elements exist in other types of cellular networks.

Core network 2250 further includes an authentication, authorization and accounting module 2252 and can further include items such as a home location registry (HLR) or visitor location registry (VLR).

MSC 2254 connects to a public switched telephone network (PSTN) 2260 for circuit switched calls. Alternatively, for mobile-to-mobile calls the MSC 2254 may connect to an MSC 2274 of core network 2270. Core network 2270 similarly has an authentication, authorization and accounting module 2272 and SGSN 2276. MSC 2274 could connect to a second mobile device through a base station controller/node B or an access point (not shown). In a further alternative embodiment, MSC 2254 may be the MSC for both mobile devices on a mobile-to-mobile call.

In accordance with the present disclosure, any network element, including mobile device 2214, BTS 2230, BSC 2232, MSC 2252, and SGSN 2256 could be used to perform the methods and encoding/decoding of FIGS. 1 to 21. In general, such network element will include a communications subsystem to communicate with other network elements, a processor and memory which interact and cooperate to perform the functionality of the network element.

Further, if the network element is a mobile device, any mobile device may be used. One exemplary mobile device is described below with reference to FIG. 23. The use of the mobile device of FIG. 23 is not meant to be limiting, but is provided for illustrative purposes.

Mobile device 2300 is a two-way wireless communication device having at least voice or data communication capabilities. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 2300 is enabled for two-way communication, it can incorporate a communication subsystem 2311, including both a receiver 2312 and a transmitter 2314, as well as associated components such as one or more, antenna elements 2316 and 2318, local oscillators (LOs) 2313, and a processing module such as a digital signal processor (DSP) 2320 The particular design of the communication subsystem 2311 depends upon the communication network in which the device is intended to operate.

When required network registration or activation procedures have been completed, mobile device 2300 may send and receive communication signals over the network 2319. As illustrated in FIG. 23, network 2319 can comprise of multiple base stations communicating with the mobile device.

Signals received by antenna 2316 through communication network 2319 are input to receiver 2312, which may perform such common receiver functions as signal amplification, frequency down conversion, filtering, channel selection and the like, and in the example system shown in FIG. 23, analog to digital (ND) conversion. A/D conversion of a received signal allows more complex communication functions such as demodulation and decoding to be performed in the DSP 2320. In a similar manner, signals to be transmitted are processed, including modulation and encoding for example, by DSP 2320 and input to transmitter 2314 for digital to analog conversion, frequency up conversion, filtering, amplification and transmission over the communication network 2319 via antenna 2318. DSP 2320 not only processes communication signals, but also provides for receiver and transmitter control. For example, the gains applied to communication signals in receiver 2312 and transmitter 2314 may be adaptively controlled through automatic gain control algorithms implemented in DSP 2320.

Network access requirements will also vary depending upon the type of network 2319. In some networks network access is associated with a subscriber or user of mobile device 2300. A mobile device may require a removable user identity module (RUIM) or a subscriber identity module (SIM) card in order to operate on a network. The SIM/RUIM interface 2344 is normally similar to a card-slot into which a SIM/RUIM card can be inserted and ejected. The SIM/RUIM card hold many key configurations 2351, and other information 2353 such as identification, and subscriber related information.

Mobile device 2300 includes a processor 2338 which controls the overall operation of the device. Communication functions, including at least data and voice communications, are performed through communication subsystem 2311. Processor 2338 also interacts with further device subsystems such as the display 2322, flash memory 2324, random access memory (RAM) 2326, auxiliary input/output (I/O) subsystems 2328, serial port 2330, one or more keyboards or keypads 2332, speaker 2334, microphone 2336, other communication subsystem 2340 such as a short-range communications subsystem and any other device subsystems generally designated as 2342. Serial port 2330 could include a USB port or other port known to those in the art.

Some of the subsystems shown in FIG. 23 perform communication-related functions, whereas other subsystems may provide “resident” or on-device functions. Notably, some subsystems, such as keyboard 2332 and display 2322, for example, may be used for both communication-related functions, such as entering a text message for transmission over a communication network, and device-resident functions such as a calculator or task list.

Operating system software used by the processor 2338 can be stored in a persistent store such as flash memory 2324, which may instead be a read-only memory (ROM) or similar storage element (not shown). Specific device applications, or parts thereof, may be temporarily loaded into a volatile memory such as RAM 2326. Received communication signals may also be stored in RAM 2326.

As shown, flash memory 2324 can be segregated into different areas for both computer programs 2358 and program data storage 2350, 2352, 2354 and 2356. These different storage types indicate each program can allocate a portion of flash memory 2324 for their own data storage requirements. Processor 2338, in addition to its operating system functions, can enable execution of software applications on the mobile device. A predetermined set of applications which control basic operations, including at least data and voice communication applications for example, will normally be installed on mobile device 2300 during manufacturing. Other applications could be installed subsequently or dynamically.

A software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application can have the ability to send and receive data items, via the wireless network 2319. In an embodiment, the PIM data items are seamlessly integrated, synchronized and updated, via the wireless network 2319, with the mobile device user's corresponding data items stored or associated with a host computer system. Further applications may also be loaded onto the mobile device 2300 through the network 2319, an auxiliary I/O subsystem 2328, serial port 2330, short-range communications subsystem 2340 or any other suitable subsystem 2342, and installed by a user in the RAM 2326 or a non-volatile store (not shown) for execution by the microprocessor 2338. Such flexibility in application installation increases the functionality of the device and may provide enhanced on-device functions, communication-related functions, or both.

In a data communication mode, a received signal such as a text message or web page download will be processed by the communication subsystem 2311 and input to the microprocessor 2338, which further processes the received signal for element attributes for output to the display 2322, or alternatively to an auxiliary I/O device 2328.

A user of mobile device 2300 may also compose data items such as email messages for example, using the keyboard 2332, which can be a complete alphanumeric keyboard or telephone-type keypad in some embodiments, in conjunction with the display 2322 and possibly an auxiliary I/O device 2328. Such composed items may then be transmitted over a communication network through the communication subsystem 2311.

For voice communications, overall operation of mobile device 2300 is similar, except that received signals would be output to a speaker 2334 and signals for transmission would be generated by a microphone 2336. Alternative voice or audio I/O subsystems, such as a voice message recording subsystem, may also be implemented on mobile device 2300. Although voice or audio signal output is accomplished primarily through the speaker 2334, display 2322 may also be used to provide an indication of the identity of a calling party, the duration of a voice call, or other voice call related information for example.

Serial port 2330 in FIG. 23 would normally be implemented in a personal digital assistant (PDA)-type mobile device for which synchronization with a user's desktop computer (not shown) may be desirable, but is an optional device component. Such a port 2330 would enable a user to set preferences through an external device or software application and would extend the capabilities of mobile device 2300 by providing for information or software downloads to mobile device 2300 other than through a wireless communication network. The alternate download path may for example be used to load an encryption key onto the device through a direct and thus reliable and trusted connection to thereby enable secure device communication. Serial port 2330 can further be used to connect the mobile device to a computer to act as a modem.

WiFi Communications Subsystem 2340 is used for WiFi Communications and can provide for communication with access point 2343.

Other communications subsystem(s) 2341, such as a short-range communications subsystem, are further components that may provide for communication between mobile device 2300 and different systems or devices, which need not necessarily be similar devices. For example, the subsystem(s) 2341 may include an infrared device and associated circuits and components or a Bluetooth™ communication module to provide for communication with similarly enabled systems and devices.

The embodiments described herein are examples of structures, systems or methods having elements corresponding to elements of the techniques of the present application. The above written description may enable those skilled in the art to make and use embodiments having alternative elements that likewise correspond to the elements of the techniques of the present application. The intended scope of the techniques of the above application thus includes other structures, systems or methods that do not differ from the techniques of the present application as described herein, and further includes other structures, systems or methods with insubstantial differences from the techniques of the present application as described herein.

1. A method comprising:
generating, at a transmitter, a burst containing a plurality of inverse discrete Fourier transform (‘IDFT’) precoded symbols and plurality of non-IDFT precoded mid-amble symbols, wherein the IDFT precoded symbols contain data for a first mobile device, and the non-IDFT precoded mid-amble symbols contain data for a second mobile device.

2. The method of claim 1, wherein the non-IDFT precoded mid-amble symbols further include a training sequence that can be used by both the second mobile device and first mobile device for channel estimation purposes.

3. The method of claim 1, wherein the data for the second mobile device includes symbols carrying uplink state flag information decodable by the second mobile device.

4. The method of claim 1, wherein data for the second mobile device includes symbols carrying piggybacked ACK/NACK information decodable by the second mobile device.

5. The method of claim 1, wherein the first and second mobile devices are the same mobile device.

6. (canceled)

7. The method of claim 1, wherein the non-IDFT precoded mid-amble symbols are modulated to be decodable by the second mobile device.

8. (canceled)

9. The method of claim 1, further comprising inserting non-IDFT precoded tail symbols at the beginning and end of the burst wherein the non-IDFT precoded tail symbols are usable by the second mobile device for signal processing purposes.

10. The method of claim 1, further comprising inserting non-IDFT precoded tail symbols at the beginning and end of the burst wherein the number of IDFT precoded symbols is reduced to accommodate the non-IDFT precoded tail symbols.

11. The method of claim 1, wherein the burst is a precoded evolved enhanced general packet radio service burst.

12. The method of claim 1, wherein at least a portion of the data for the second mobile device is also included in the IDFT precoded symbols of the burst.

13. The method of claim 1, further comprising checking, prior to the generating the burst, whether all mobile devices multiplexed on a timeslot can decode the burst containing only IDFT precoded symbols, and if yes, including the non-IDFT precoded symbols into the IDFT precoded symbols of the burst.

14. The method of claim 1, wherein the IDFT precoded symbols include a cyclic prefix and encrypted bits and wherein the non-IDFT precoded symbols include encrypted bits and training sequence bits.

15. (canceled)

16. A transmitter comprising:
a processor
configured-to:
generate a burst containing a plurality of inverse discrete Fourier transform (‘IDFT’) precoded symbols and plurality of non-IDFT precoded mid-amble symbols, wherein the IDFT precoded symbols contain data for a first mobile device, and the non-IDFT precoded mid-amble symbols contain data for a second mobile device.

17. (canceled)

18. The of claim 16, wherein the non-IDFT precoded mid-amble symbols further include a training sequence that can be used by both the second mobile device and first mobile device for channel estimation purposes.

19. The transmitter of claim 16, wherein data for the second mobile device includes symbols carrying piggybacked ACK/NACK information decodable by the second mobile device.

20. The transmitter of claim 16, wherein the first mobile device and the second mobile device are multiplexed on a same timeslot.

21. (canceled)

22. The transmitter of claim 16, wherein the processor and communications subsystem further cooperate to insert a plurality of non-IDFT precoded tail symbols at the beginning and at the end of the burst.

23. (canceled)

24. (canceled)

25. (canceled)

26. (canceled)

27. (canceled)

28. The transmitter of claim 16, wherein the processor and communications subsystem further cooperate to signal a burst format to a receiver.

29. A method at a receiver for decoding a burst, the method comprising:
utilizing a first burst format and a second burst format to decode the burst; and
checking whether a cyclic redundancy check for a portion of data which is part of the burst matches for one of the first burst format decoding and second burst format decoding, and
if yes, using the matching one of the first format decoded and second format decoded burst.

30. (canceled)

31. A method at a receiver for decoding a burst, the method comprising:
decoding the burst with both a first burst format and a second burst format; and
using the decoded burst having the less noisy uplink state flag.

32. (canceled)
